(19) United States
(12) Patent Application Publication
(10) Pub. No.: US 2022/0335532 A1
(43) Pub. Date: Oct. 20, 2022

(54) COMPUTER IMPLEMENTED METHOD FOR RATING AN INSURABLE RISK

(71) Applicant: Mark A. Virag, Atlanta, GA (US)

(72) Inventor: Mark A. Virag, Atlanta, GA (US)

(21) Appl. No.: 17/721,113

(22) Filed: Apr. 14, 2022

Related U.S. Application Data
(60) Provisional application No. 63/176,235, filed on Apr. 17, 2021.

(51) Int. Cl. G06Q 40/08; G06Q 10/06; G06Q 10/00; G06N 5/00; G06K 9/62

(52) U.S. Cl. CPC G06Q 40/08; G06Q 10/0635; G06Q 10/20; G06N 5/003; G06K 9/6256

(57) ABSTRACT

A computer implemented method for rating a particular insurable risk includes receiving insurance data into a network computer memory connected to a computer network. The insurance data includes potential insured characteristics regarding a potential insured associated with the particular insurable risk, particular asset identifying information regarding a particular asset associated with the particular insurable risk, and particular contract terms of a particular asset-related contract associated with the particular insurable risk. The method further includes determining particular asset characteristics based on the particular asset identifying information, and determining, via an Artificial Intelligence (AI) Engine in the computer network, a risk estimate for the particular insurable risk based on a risk model determined by the AI Engine. The method includes transforming the risk estimate to a premium via the computer network, and communicating the premium via the computer network.

### CROSS-REFERENCE TO RELATED APPLICATION

This application claims the benefit of U.S. Provisional Application Ser. No. 63/176,235, filed Apr. 17, 2021, which is incorporated by reference herein in its entirety.

### BACKGROUND

Insurance is a contract, represented by a written insurance policy, in which an insurance company provides financial protection or reimbursement against losses to an insured individual or entity. The insurance company aggregates risks of a group of insured clients to make premiums more affordable for the insured.

Some insurance policies may be used to protect against the risk of financial losses that may result from damage to the insured or property owned or used by the insured. Other insurance policies may be used to protect against the risk of financial losses that may result from liability for damage or injury caused to a third party. Still other insurance policies, sometimes called vehicle service contracts, may be used to protect against the risk of unexpected expenses from servicing a vehicle.

There are many different types of insurance policies available. The most common types of personal insurance policies are auto, health, homeowners, and life. Some insurance policies insure businesses against specific types of risks. For example, a fast-food restaurant may have a policy that covers damage or injury that occurs as a result of cooking with a deep fryer. An auto dealer may seek coverage for damage or injury that could occur during test drives.

Insurable risks generally include an element of serendipity. That is, an event that triggers a claim has an element of chance associated with it, or it is at least outside of the control of the beneficiary of the insurance policy. Events that contain speculative elements, such as ordinary business risks, may, in some cases not be considered insurable.

Some insurance companies evaluate a likelihood of being required to pay for a covered loss. This evaluation process is called “rating.” The better an insurance company's rating process, the more likely the insurance company will be able to meet the insurance company's claims obligations while providing fair value to their customers.

The structure of the connections and data exchanged and processed in the present disclosure are technological improvements to the technology of rating systems brought about by structuring, using and processing data in new ways disclosed herein.

### SUMMARY

A computer implemented method for rating a particular insurable risk includes receiving insurance data into a network computer memory connected to a computer network. The insurance data includes potential insured characteristics regarding a potential insured associated with the particular insurable risk, particular asset identifying information regarding a particular asset associated with the particular insurable risk, and particular contract terms of a particular asset-related contract associated with the particular insurable risk. The method further includes determining particular asset characteristics based on the particular asset identifying information, and determining, via an AI Engine in the computer network, a risk estimate for the particular insurable risk based on a risk model determined by the AI Engine. The method includes transforming the risk estimate to a premium via the computer network, and communicating the premium via the computer network.

In a first aspect, a computer implemented method for rating a particular insurable risk, comprises: receiving insurance data into a network computer memory connected to a computer network, wherein the insurance data includes: potential insured characteristics regarding a potential insured associated with the particular insurable risk; particular asset identifying information regarding a particular asset associated with the particular insurable risk; and particular contract terms of a particular asset-related contract associated with the particular insurable risk; determining particular asset characteristics based on the particular asset identifying information; determining, via an AI Engine in the computer network, a risk estimate for the particular insurable risk based on a risk model determined by the AI Engine; transforming the risk estimate to a premium via the computer network; and communicating the premium via the computer network.

In an example of the first aspect, the AI Engine includes an Artificial Neural Network. In an example, the Artificial Neural Network includes a Deep Neural Network. In an example of the first aspect, the AI Engine includes a Gradient Boosted Regression Tree. In an example of the first aspect, the AI Engine includes a Generalized Linear Model. In an example, the Generalized Linear Model is based on a Tweedie distribution.

In an example of the first aspect, the particular asset includes a vehicle; the particular asset identifying information includes a particular Vehicle Identification Number; and the particular asset-related contract associated with the particular insurable risk includes a vehicle service contract.

In an example of the first aspect, the particular contract terms include a scope of coverage that includes maintenance, repair or replacement of components of a vehicle that warrant repair or replacement due to causes for which coverage is provided in the particular asset-related contract.

In an example of the first aspect, the risk estimate is expressed in currency for a time period, and the risk model determined by the AI Engine is a continuous function.

An example of the first aspect further comprises: receiving the potential insured characteristics, the particular asset identifying information, and the particular contract terms by a Risk Estimating API; communicating, via the Risk Estimating API: the particular asset identifying information to the computer network; and the particular contract terms and the potential insured characteristics to the AI Engine; receiving, from the computer network, the particular asset characteristics by the AI Engine; and communicating, via the Risk Estimating API, the potential insured characteristics and the particular contract terms to the AI Engine.

An example further comprises: communicating, via a Rates API, the potential insured characteristics, the particular asset identifying information, and the particular contract terms to the Risk Estimating API; communicating, via the Risk Estimating API, the particular asset identifying information to an Asset Characteristics Query API; communicating, via the Asset Characteristics Query API, the particular asset identifying information to an Asset Data Service; receiving, by the Asset Characteristics Query API, the particular asset characteristics from the Asset Data Service; and communicating, via the Asset Characteristics Query API, the particular asset characteristics to the AI Engine, wherein the receiving the insurance data into the network computer memory is via a point-of-sale system.

An example further comprises: communicating the risk estimate to the Risk Estimating API; communicating, via the Risk Estimating API, the risk estimate to a Premium Markup API; determining, via the Premium Markup API, the premium based on the risk estimate; communicating, via the Premium Markup API, the premium to a receiver on the computer network.

An example further comprises: communicating the risk estimate to the Risk Estimating API; communicating, via the Risk Estimating API, the risk estimate to a Premium Markup API; determining, via the Premium Markup API, the premium based on the risk estimate; communicating, via the Premium Markup API, the premium to the Rates API; and communicating the premium via the Rates API to the point-of-sale system.

An example further comprises: communicating, via the Premium Markup API, the premium to a Rates API, wherein the Rates API is the receiver on the computer network; and communicating the premium via the Rates API to a point-of-sale system.

In an example of the first aspect, the communicating the premium via the computer network includes communicating the premium via a point-of-sale system, and the communicating the premium via the point-of-sale system is selected from the group consisting of: displaying the premium on a display connected to the point-of-sale system; printing the premium on media by a printer connected to the point-of-sale system; producing sounds from the point-of-sale system that communicate the premium; and saving data on a removable computer memory in communication with the point-of-sale system.

In an example of the first aspect, the communicating the premium via the computer network includes communicating the premium via a point-of-sale system, and the communicating the premium via the point-of-sale system is selected from the group consisting of: displaying the premium on a display connected to the point-of-sale system; printing the premium on media by a printer connected to the point-of-sale system; producing sounds from the point-of-sale system that communicate the premium; and saving data on a removable computer memory in communication with the point-of-sale system.

In an example of the first aspect, a point-of-sale system connected to the computer network is selected from the group consisting of: a smart phone; a PC; a tablet computer; a computer terminal; a computer workstation; and a notebook computer.

An example of the first aspect further comprises: training the risk model with training data including related asset characteristics of related assets, historical insured characteristics and cost-related data.

In an example, the cost-related data is selected from the group consisting of: a cost of maintaining, repairing or replacing a component of the related assets; a quantity of a component that is associated with the related asset; and a service interval between service events

In an example, the related asset characteristics include related features encoded into related Vehicle Identification Numbers and the particular asset characteristics include particular features encoded into a particular Vehicle Identification Number.

An example further comprises: receiving, via a Training System connected to the computer network, the historical insured characteristics, related asset identifying information regarding the related assets, related contract terms and the cost-related data; communicating, from the Training System, the historical insured characteristics, the related contract terms and the cost-related data to the AI Engine; communicating, from the Training System, the related asset identifying information to an Asset Characteristics Query API connected to the computer network; communicating, from the Asset Characteristics Query API, the related asset identifying information to an Asset Data Service connected to the computer network; communicating, from the Asset Data service, the related asset characteristics to the Asset Characteristics Query API; and communicating, from the Asset Characteristics Query API, the related asset characteristics to the AI Engine.

It is to be understood that any features of the first aspect of the computer implemented method disclosed herein may be combined together in any desirable manner and/or configuration to achieve the benefits as described in this disclosure.

In a second aspect, an AI system comprises an AI Engine to determine a risk model for a domain of insurable risks, and to determine a risk estimate for a particular insurable risk by applying the particular insurable risk to the risk model, wherein: the particular insurable risk includes particular contract terms; the particular contract terms include insurance coverage for the particular insurable risk; the risk model is to be trained based on a cost of covering related contract terms for related assets having relationships to the particular insurable risk and for historical insureds having relationships to the particular insurable risk; the relationships of the related assets to the particular insurable risk are to be determined by the AI Engine; and the relationships of the historical insureds to the particular insurable risk are to be determined by the AI Engine.

In an example of the second aspect, the related assets include vehicles and components of the vehicles; the particular contract terms include terms of a particular vehicle service contract; and the related contract terms include terms for a related vehicle service contract.

In an example of the second aspect, the risk model is a continuous function of risk factors, and the risk factors are determined by the AI Engine.

An example of the second aspect, further comprises: a Risk Estimating API connected to a computer network to receive particular asset identifying information regarding a particular asset associated with the particular insurable risk, potential insured characteristics regarding a potential insured associated with the particular insurable risk, and the particular contract terms of a particular asset-related contract associated with the particular insurable risk, the Risk Estimating API to communicate the potential insured characteristics and the particular contract terms to the AI Engine, the Risk Estimating API to communicate the particular asset identifying information to an Asset Characteristics Query API, and the Risk Estimating API to receive the risk estimate from the AI Engine, wherein the Asset Characteristics Query API is to receive the particular asset identifying information from the Risk Estimating API, wherein the Asset Characteristics Query API is to communicate the particular asset identifying information to an asset data service connected to the computer network, and wherein the Asset Characteristics Query API is to receive particular asset characteristics from the asset data service, wherein the Asset Characteristics Query API is to communicate the particular asset characteristics to the AI Engine.

An example of the second aspect, further comprises a point-of-sale system connected to a computer network, wherein the AI Engine is connected to the computer network, and wherein the point-of-sale system is to receive potential insured characteristics regarding a potential insured associated with the particular insurable risk, particular asset identifying information regarding a particular asset associated with the particular insurable risk, and the particular contract terms of a particular asset-related contract associated with the particular insurable risk; a Rates API connected to the computer network to receive the particular asset identifying information, the potential insured characteristics, and the particular contract terms from the point-of-sale system; a Risk Estimating API connected to the computer network to receive the particular asset identifying information, the potential insured characteristics, and the particular contract terms from the Rates API, the Risk Estimating API to communicate the potential insured characteristics and the particular contract terms to the AI Engine, the Risk Estimating API to communicate the particular asset identifying information to an Asset Characteristics Query API, and the Risk Estimating API to receive the risk estimate from the AI Engine; and the Asset Characteristics Query API connected to the computer network to receive the particular asset identifying information from the Risk Estimating API, the Asset Characteristics Query API to communicate the particular asset identifying information to an asset data service connected to the computer network, the Asset Characteristics Query API to receive particular asset characteristics from the asset data service, the Asset Characteristics Query API to communicate the particular asset characteristics to the AI Engine.

In an example, the particular asset characteristics include particular features encoded into a particular Vehicle Identification Number.

In an example, the particular asset characteristics include particular features encoded into a particular Vehicle Identification Number.

An example further comprises a Premium Markup API connected to a computer network to receive the risk estimate from the AI engine, wherein: the Premium Markup API is to determine a premium based on the risk estimate; the Premium Markup API is to communicate the premium to a Rates API connected to the computer network; the Rates API is to communicate the premium to a point-of-sale system; and the point-of-sale system is to communicate the premium.

In an example, the point-of-sale system is to communicate the premium by performing an action selected from the group consisting of: displaying the premium on a display connected to the point-of-sale system; printing the premium on media by a printer connected to the point-of-sale system; producing sounds from the point-of-sale system that communicate the premium; and saving data on a removable computer memory in communication with the point-of-sale system.

An example of the second aspect further comprises: a training system connected to a computer network wherein the AI Engine is connected to the computer network, and wherein the training system is to communicate historical insured characteristics regarding the historical insureds associated with the related assets, related asset identifying information regarding the related assets, the related contract terms and cost-related data to the AI Engine wherein the computer network is to connect to an Asset Characteristics Query API to receive the related asset identifying information from the Training System, the Asset Characteristics Query API to communicate the related asset identifying information to an Asset Data Service connected to the computer network, the Asset Characteristics Query API to receive related asset characteristics from the Asset Data Service, the Asset Characteristics Query API to communicate the related asset characteristics to the AI Engine.

In an example, the related asset characteristics include related features encoded into related Vehicle Identification Numbers. In an example, the AI Engine includes an Artificial Neural Network. In an example, the Artificial Neural Network includes a Deep Neural Network. In an example, the AI Engine includes a Gradient Boosted Regression Tree. In an example, the AI Engine includes a Generalized Linear Model. In an example, the Generalized Linear Model is based on a Tweedie distribution.

It is to be understood that any features of this AI System may be combined together in any desirable manner. Moreover, it is to be understood that any combination of features of this AI system and/or of the first aspect of the computer implemented method disclosed herein may be used together, and/or combined with any of the examples disclosed herein to achieve the benefits as described in this disclosure.

In a third aspect, a computer implemented method for rating a particular insurable risk, comprises: receiving insurance data into a network computer memory connected to a computer network, wherein the insurance data includes: potential insured characteristics regarding a potential insured associated with the particular insurable risk; a particular Vehicle Identification Number for a particular vehicle associated with the particular insurable risk; and particular contract terms of a particular vehicle service contract associated with the particular insurable risk; determining particular vehicle characteristics based on the particular Vehicle Identification Number; training, via an AI Engine in the computer network, a risk model with training data including related vehicle characteristics of related vehicles, historical insured characteristics and cost-related data; determining, via the AI Engine, a risk estimate for the particular insurable risk based on the risk model; transforming the risk estimate to a premium via the computer network; and communicating the premium via the computer network.

In an example of the third aspect, the AI Engine includes an Artificial Neural Network. In an example, the Artificial Neural Network includes a Deep Neural Network. In an example of the third aspect, the AI Engine includes a Gradient Boosted Regression Tree. In an example of the third aspect, the AI Engine includes a Generalized Linear Model. In an example, the Generalized Linear Model is based on a Tweedie distribution. In an example,

In an example of the third aspect, the cost-related data is selected from the group consisting of: a cost of maintaining, repairing or replacing a component of the related vehicle; a quantity of a component that is associated with the related vehicle; and a service interval between service events.

In an example of the third aspect, the related vehicle characteristics include related features encoded into related Vehicle Identification Numbers and wherein the particular vehicle characteristics include particular features encoded into the particular Vehicle Identification Number.

In an example of the third aspect, the particular contract terms include a scope of coverage that includes maintenance, repair or replacement of components that warrant repair or replacement due to causes for which coverage is provided in the particular vehicle service contract.

In an example of the third aspect, the risk estimate is expressed in currency for a time period, and the risk model determined by the AI Engine is a continuous function.

An example of the third aspect further comprises: receiving, via a Training System connected to the computer network, the historical insured characteristics, related Vehicle Identification Numbers for the related vehicles, related contract terms and the cost-related data; communicating, from the Training System, the historical insured characteristics, the related contract terms and the cost-related data to the AI Engine; communicating, from the Training System, the related Vehicle Identification Numbers to an Asset Characteristics Query API connected to the computer network; communicating, from the Asset Characteristics Query API, the related Vehicle Identification Numbers to a Vehicle Data Service connected to the computer network; communicating, from the Vehicle Data service, the related vehicle characteristics to the Asset Characteristics Query API; and communicating, from the Asset Characteristics Query API, the related vehicle characteristics to the AI Engine.

An example of the third aspect further comprises: receiving the potential insured characteristics, the particular Vehicle Identification Number, and the particular contract terms by a Risk Estimating API; communicating, via the Risk Estimating API: the particular Vehicle Identification Number to the computer network; and the particular contract terms and the potential insured characteristics to the AI Engine; receiving, from the computer network, the particular vehicle characteristics by the AI Engine; and communicating, via the Risk Estimating API, the potential insured characteristics and the particular contract terms to the AI Engine.

An example of the third aspect further comprises: communicating, via a Rates API, the potential insured characteristics, the particular Vehicle Identification Number, and the particular contract terms to a Risk Estimating API; communicating, via the Risk Estimating API, the particular Vehicle Identification Number to an Asset Characteristics Query API; communicating, via the Asset Characteristics Query API, the particular Vehicle Identification Number to a Vehicle Data Service; receiving, by the Asset Characteristics Query API, the particular vehicle characteristics from the Vehicle Data Service; and communicating, via the Asset Characteristics Query API, the particular vehicle characteristics to the AI Engine, wherein the receiving the insurance data into the network computer memory is via a point-of-sale system.

An example further comprises: communicating the risk estimate to the Risk Estimating API; communicating, via the Risk Estimating API, the risk estimate to a Premium Markup API; determining, via the Premium Markup API, the premium based on the risk estimate; communicating, via the Premium Markup API, the premium to a Rates API connected to the computer network; and communicating the premium via the Rates API to a receiver on the computer network.

An example further comprises: communicating the risk estimate to the Risk Estimating API; communicating, via the Risk Estimating API, the risk estimate to a Premium Markup API; determining, via the Premium Markup API, the premium based on the risk estimate; communicating, via the Premium Markup API, the premium to the Rates API; and communicating the premium via the Rates API to the point-of-sale system.

An example further comprises: communicating, via the Rates API, the premium to a point-of-sale system, wherein the point-of-sale system is the receiver on the computer network.

In an example of the third aspect, the communicating the premium via the computer network includes communicating the premium via a point-of-sale system, and the communicating the premium via the point-of-sale system is selected from the group consisting of: displaying the premium on a display connected to the point-of-sale system; printing the premium on media by a printer connected to the point-of-sale system; producing sounds from the point-of-sale system that communicate the premium; and saving data on a removable computer memory in communication with the point-of-sale system. In an example the point-of-sale system is selected from the group consisting of: a smart phone; a PC; a tablet computer; a computer terminal; a computer workstation; and a notebook computer.

Some examples comprise a non-transitory computer-readable medium to store instructions that when executed by a processor, perform operations including one or more of the system or computer implemented method elements.

It is to be understood that any features of the computer implemented methods disclosed herein may be combined together in any desirable manner. Moreover, it is to be understood that any combination of features of the computer implemented methods and/or of the AI system may be used together, and/or combined with any of the examples disclosed herein to achieve the benefits as described in this disclosure.

As disclosed herein, Artificial Intelligence provides electronic computing systems with the ability to automatically learn and improve from experience without being explicitly programmed. The present disclosure is directed to more than math, but to technical systems and methods that provide improvements to rating systems implemented on improved computer systems. Artificial Intelligence concerns computing solely in a technical environment to which problem situations are structured through models. The data structures associated with AI are distinct from the manner in which a human thinks, and the processing of data structures associated with the AI System of the present disclosure is not an exercise in abstract thinking, nor divorceable from the technical environment. Some AI systems, including AI Systems as disclosed herein, must deal with data at volumes and speeds that the term “mere automation” does not apply in the sense that a machine is merely doing that which a human may do. With the present disclosure, augmentation beyond mere automation includes components for a system whose functionality is currently not captured in any manual process. Some traditional techniques that apply simple statistical methods have met limitations in the art of rating systems because of size and complexity of data and data structures. The AI Systems and computer implemented methods disclosed herein overcome such limitations. Examples of the AI systems and computer implemented methods disclosed herein may provide pattern recognition that is beyond the capabilities of traditional statistical methods. Improvements in analysis and predictive performance of rating systems may be advanced with the fast and efficient AI Systems and computer implemented methods disclosed herein.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a block diagram illustrating an example of an AI system operating on a computer network as disclosed herein;

FIG. 2 is a block diagram illustrating a training view of the AI system and computer network as depicted in FIG. 1 as disclosed herein;

FIG. 3-FIG. 16 together are a flow chart depicting an example of a computer implemented method for rating a particular insurable risk as disclosed herein; and

FIG. 17-FIG. 26 together are a flow chart depicting another example of the computer implemented method for rating a particular insurable risk as disclosed herein.

### DETAILED DESCRIPTION

Some insurance companies determine a premium for an insured by determining a rating class of similar insurable risks. As used herein, in context similar to the previous sentence, “insured” means a person, group, or entity with an interest, such as life or property, that is covered by an insurance policy. As used herein, “historical insured” means an insured that was covered by an insurance policy in the past. Also as used herein, “potential insured” means a person, group, or entity with an interest that is to be rated for an insurance policy.

In some insurance policies, members of a rating class are all charged substantially the same premium. In some cases, there may be discounts provided for various marketing reasons. In a simplified example of auto liability insurance, automobiles with a powerful engine may be in a rating class. The insurance company may assume that, on average, automobiles with a powerful engine may cost the insurance company a certain amount in claims over a certain period of time. Some of the members of the powerful engine class may not have claims, and some of the members of the class may have large claims. In this simplified example, the premium for the liability insurance for each member of the class is substantially the same. However, suppose that one member of the powerful engine class is an inexpensive vehicle that is rarely driven. In such a situation, the inexpensive vehicle may seem to be getting less value in the insurance contract compared to an expensive, frequently driven member of the powerful engine class.

If there is a large quantity of insured vehicles in the powerful engine class, the average cost to provide liability coverage may be predictable with a high degree of certainty. However, if the cost of coverage is normally distributed, then, over a long period of time, about one half of the vehicles will pay more for their liability insurance than they receive in benefits. Some members of this half may feel like they did not get good value in their liability insurance deal. Other members will pay less for their liability insurance than they receive in benefits. These members may be delighted with the insurance deal.

In general, the more similar the members are in an insurance rating class, the more “fair” the premiums may seem to the members. The ratings practices of some insurance companies provide relatively broad rating classes that include a relatively wide variety of risk characteristics. The risk models generated by such ratings practices have abrupt differences when moving from one class to another.

The method and systems of the present disclosure apply Artificial Intelligence (AI) to produce a risk model that is a continuous function. The risk estimates generated by the risk models according to the present disclosure are expressed in currency for a time period, rather than allocation to a rating class. Thus, the method and systems of the present disclosure provide granular risk models that better represent the actual risk for each insured. The accuracy of the risk models generated by the method and systems of the present disclosure benefits the insurance company and the insured. More accurate risk models reduce the financial risk for the insurance company. More accurate risk models also produce risk estimates that are more appropriate to the particular insurable risk of each insured.

Some examples of the present disclosure include a computer implemented method for rating a particular insurable risk. As used herein, “rating” means determining a likelihood of experiencing a covered loss under an insurance policy. As used herein, an “insurable risk” means a risk that meets criteria for coverage in an insurance policy. Insurance may not be effective for risks that are not insurable risks. In some cases, insurable risks meet the following criteria: 1) The insurer is able to charge a premium high enough to cover not only claims expenses, but also to cover the insurer's expenses. In other words, catastrophic risks are not normally acceptable. Normally, risks are not so large that an insurer would be unable to pay for the loss. Risks that are too large may not be insurable risks. When risks are too large, the premiums could be too high to be affordable. 2) The nature of the loss should be definite and financially measurable. That is, there should not be disputes as to whether or not payment is due, nor as to what amount the payment should be. Risks that are not measurable, if insured, may be difficult for the insurer to quantify, and thus the insurer cannot charge the correct premium. The insurer will need to charge a conservatively high premium in order to mitigate the risk of paying a claim that is too large. The premium will thus be higher than ideal, and inefficient. 3) The loss should be random in nature. If the loss is not at least random in part, adverse selection can occur. Adverse selection is a market situation where insurers and insureds have different information, such that a participant might participate selectively in contracts which benefit the informed participant the most, at the expense of the uninformed party.

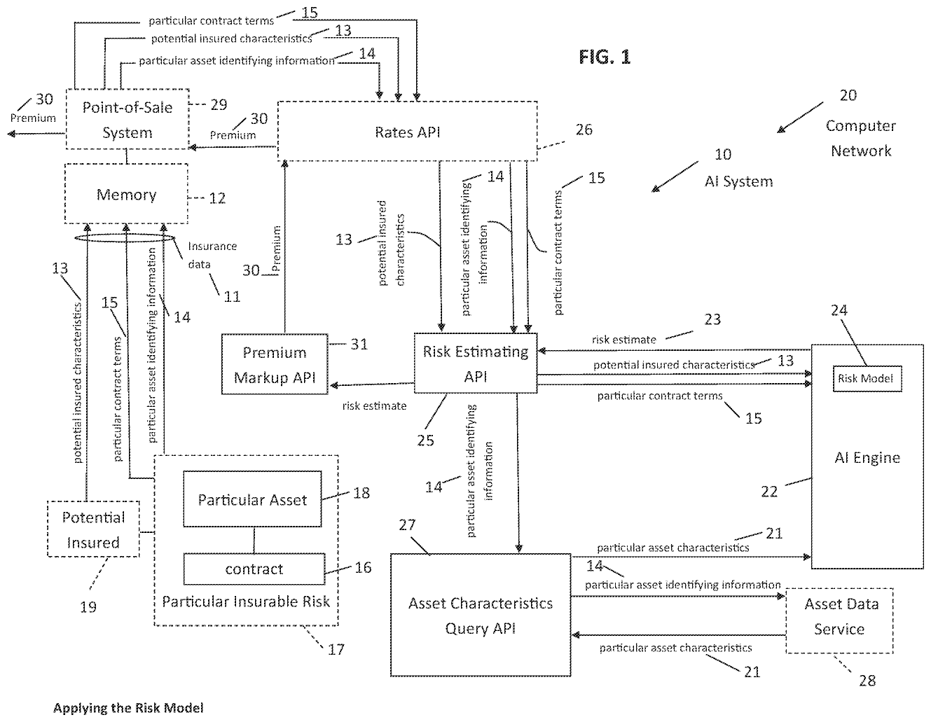

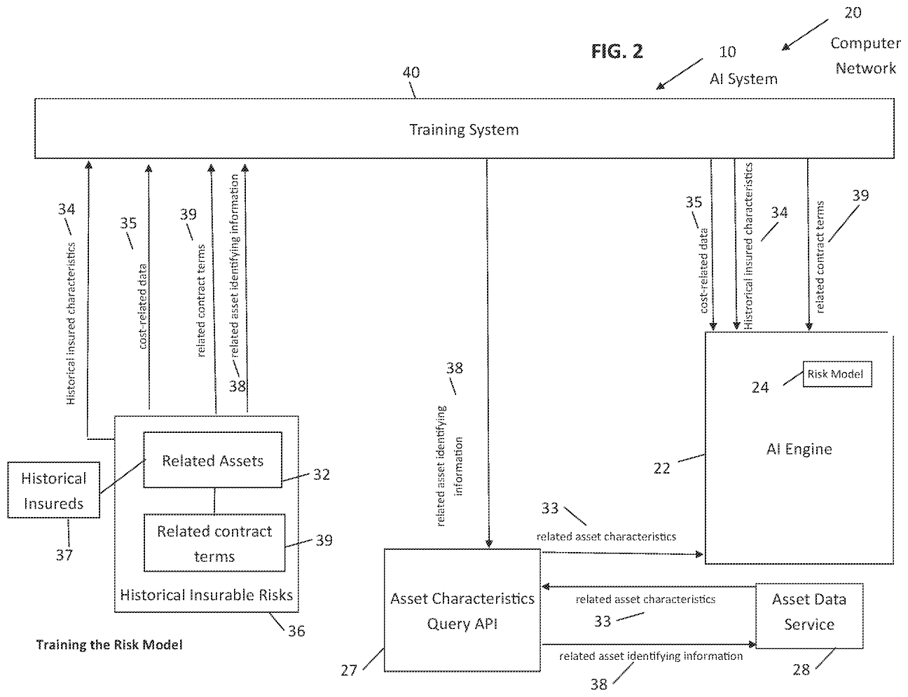

FIG. 1 is a block diagram illustrating an example of an AI system operating on a computer network as disclosed herein. FIG. 2 is a block diagram illustrating a training view of the AI system and computer network as depicted in FIG. 1. Examples of the computer implemented methods of the present disclosure may be better understood with reference to the block diagrams in FIG. 1 and FIG. 2.

In some examples of the present disclosure, the computer implemented method includes receiving insurance data 11 into a network computer memory 12 connected to a computer network 20. The insurance data 11 may include potential insured characteristics 13, particular asset identifying information 14, and particular contract terms 15 of a particular asset-related contract 16 associated with the particular insurable risk 17. The particular asset-related contract 16 associated with the particular insurable risk 17 may include a vehicle service contract. The potential insured characteristics 13 may regard a potential insured 19 associated with the particular insurable risk 17. The particular asset identifying information 14 may regard a particular asset 18 associated with the particular insurable risk 17.

In some examples of the present disclosure, the computer implemented method may include determining particular asset characteristics 21 based on the particular asset identifying information 14. In some examples, the particular asset 18 may include a vehicle or group (i.e., fleet) of vehicles. The particular asset identifying information 14 may include a particular Vehicle Identification Number (VIN) or group of VINs. The particular asset-related contract 16 associated with the particular insurable risk 17 may include a vehicle service contract.

As used herein, “vehicle service contract” means a contract or agreement for a separately stated consideration or for a specific duration to perform the repair, replacement, or maintenance of a motor vehicle for the operational or structural failure of the motor vehicle due to a defect in materials, workmanship, or normal wear and tear. There may be other coverage terms, conditions, and limitations that may apply to a vehicle service contract. In some examples of the present disclosure, the particular contract terms 15 may include a scope of coverage that includes maintenance, repair or replacement of components of a vehicle that warrant repair or replacement due to causes for which coverage is provided in the particular asset-related contract 16.

Vehicle service contracts are sometimes referred to as “extended warranties” because they can extend a manufacturer's warranty for a specified period of time. A difference between a warranty (provided by the manufacturer, retailer, or other entity in the product's chain of distribution) and service contract is that a consumer must pay an additional sum of money for the service contract instead of having the cost be included in the purchase price of the covered product. In an example of the present disclosure, the particular contract terms 15 may include warranty terms.

Vehicle service contracts may, in some jurisdictions, be regulated by government insurance departments with the governing laws and regulations included in an insurance code. In some jurisdictions, regulating authorities classify vehicle service contracts as noninsurance products. It is to be understood that the present disclosure uses terms like “insurance” and “insurable” in a broad risk management context, which is not necessarily for determination as to whether or not a particular consumer protection authority has jurisdiction over the disclosed subject matter.

In some examples of the present disclosure, the computer implemented method includes determining, via an AI Engine 22 in the computer network 20, a risk estimate 23 for the particular insurable risk 17 based on a risk model 24 determined by the AI Engine 22. In some examples, the AI Engine 22 may include an Artificial Neural Network. In some examples the Artificial Neural Network may include a Deep Neural Network. In some examples the AI Engine 22 may include a Gradient Boosted Regression Tree. In some examples the AI Engine 22 may include a Generalized Linear Model. In some examples the Generalized Linear Model may be based on a Tweedie distribution.

In some examples of the present disclosure, the computer implemented method may include receiving the potential insured characteristics 13, the particular asset identifying information 14, and the particular contract terms 15 by a Risk Estimating API 25. As used herein, an Application Programming Interface (API) means a set of programming code that enables data exchange between one software application and another; along with the terms of this data exchange. APIs may include two components: 1) Technical specification describing the data exchange options between the software applications with the specification done in the form of a request for processing and data delivery protocols; and 2) a software interface written to the specification that represents it. For example, a first software application that wants to access information (e.g., particular asset characteristics 21) from a second software application, calls its API while specifying the requirements of how data/functionality must be provided (e.g., first software application sends particular asset identifying information 14 and second software application returns particular asset characteristics 21 that are associated with the particular asset identifying information 14). The second software application returns the data/functionality (e.g., particular asset characteristics 21) requested by the first software application. The interface by which these two applications communicate is what the API specifies.

The computer implemented method may include communicating, via the Risk Estimating API 25, the particular asset identifying information 14 to the computer network 20. The computer implemented method may include communicating, via the Risk Estimating API 25, the particular contract terms 15 and the potential insured characteristics 13 to the AI Engine 22. The computer implemented method may include receiving, from the computer network 20, the particular asset characteristics 21 by the AI Engine 22. The computer implemented method may include communicating, via the Risk Estimating API 25, the potential insured characteristics 13 and the particular contract terms 15 to the AI Engine 22.

In some examples of the present disclosure, the computer implemented method may include communicating, via a Rates API 26, the potential insured characteristics 13, the particular asset identifying information 14, and the particular contract terms 15 to the Risk Estimating API 25. The computer implemented method may include communicating, via the Risk Estimating API 25, the particular asset identifying information 14 to an Asset Characteristics Query API 27. The computer implemented method may include communicating, via the Asset Characteristics Query API 27, the particular asset identifying information 14 to an Asset Data Service 28. The computer implemented method may include receiving, by the Asset Characteristics Query API 27, the particular asset characteristics 21 from the Asset Data Service 28. The computer implemented method may include communicating, via the Asset Characteristics Query API 27, the particular asset characteristics 21 to the AI Engine 22.

As disclosed herein, the Asset Data Service 28 may be any computerized data service for providing asset characteristics associated with assets identified by asset identifying information. For example, The U.S. Federal Aviation Administration (FAA) maintains a database of aircraft registrations, or tail numbers for civil aircraft. The Asset Data Service 28 could provide asset characteristics about any asset, including, for example: fine art, jewelry, real estate, aircraft, watercraft, automobiles, trucks, motorcycles, books, and instruments. Manufacturers may keep records of products produced and provide access to the data to authorized users. As disclosed herein, the Asset Data Service 28 may provide services such as querying a database with asset identifying information, such as a Vehicle Identification Number, and returning asset characteristics such as a model of the vehicle having the VIN in the query. Vehicle Identification Numbers are unique identifying codes for a particular vehicle. There are standards for VINs in various jurisdictions. For example, in the United States in 2021, a VIN is composed of 17 characters (digits and capital letters). A VIN is encoded with the vehicle's unique features, specifications and manufacturer. As an example, the following assignments have been given to each position (from left to right) in a 17 position VIN.

TABLE 1

| Position(s) | Information Encoded |
|---|---|
| 1-3 | World Manufacturer Identifier |
| 4 | Restraint System Type |
| 5-7 | Make, Car Line, Series, Body Type |
| 8 | Engine Type - Displacement, Cylinders, |
| | Fuel Type, Manufacturer and Horsepower |
| 9 | VIN Check Digit (0-9 or X) |
| 10 | Vehicle, Model Year |
| 11 | Plant or Manufacturer |
| 12-17 | Numerical Sequence Number Identifier |

Since the 17 digit VIN can have English capital letters and numerals in each position, the number of potential combinations is practically limitless. Some vehicle manufacturers encode detailed information into the VIN. The following is a list of some of the vehicle characteristics that can be determined using a VIN decoder available from the United States National Highway Traffic Safety Administration (NHTSA):

TABLE 2

| Index No. | Vehicle Characteristic |
|---|---|
| 1 | Model Year |
| 2 | Make |
| 3 | Model |
| 4 | Trim |
| 5 | Turbo |
| 6 | Drive Type |
| 7 | Fuel Type-Primary |
| 8 | Plant City |
| 9 | Body Class |
| 10 | Engine Number of Cylinders |
| 11 | Displacement (CC) |
| 12 | Doors |
| 13 | Windows |
| 14 | Engine Power (KW) |
| 15 | Number of Seats |
| 16 | Series |
| 17 | Transmission Style |
| 18 | Curtain Air Bag Locations |
| 19 | Valvetrain Design |
| 20 | Transmission Speeds |
| 21 | Engine Brake (hp) |
| 22 | Adaptive Cruise Control (ACC) |
| 23 | Adaptive Headlights |
| 24 | Antilock Braking System (ABS) |
| 25 | Crash Imminent Braking (CIB) |
| 26 | Blind Spot Detection (BSD) |
| 27 | Electronic Stability Control (ESC) |
| 28 | Traction Control |
| 29 | Forward Collision Warning (FCW) |
| 30 | Lane Departure Warning (LDW) |
| 31 | Lane Keeping Support (LKS) |
| 32 | Rear Visibility System (RVS) |
| 33 | Parking Assist |
| 34 | Wheelbase (inches) |
| 35 | Base Price ($) |
| 36 | Dynamic Brake Support (DBS) |
| 37 | Pedestrian Automatic Emergency Braking (PAEB) |
| 38 | Keyless Ignition |
| 39 | Daytime Running Light (DRL) |
| 40 | Lower Beam Headlamp Light Source |
| 41 | Semiautomatic Headlamp Beam Switching |
| 42 | Adaptive Driving Beam (ADB) |
| 43 | SAE Automation Level |
| 44 | Rear Cross Traffic Alert |

Some existing rating systems for vehicle service contracts may consider only the first six characteristics from Table 2, thus generating rating classes that are relatively broad, and risk estimates that cannot achieve the accuracy and granularity of the risk estimates generated by the systems and methods of the present disclosure.

The AI Engine 22 disclosed herein may be capable of finding patterns in the combination of asset characteristics gleaned from VIN information, cost-related data, insured characteristics, and contract terms. Suppose, for example, during a particular model year, the glass for the windshield of a particular model vehicle drifted to be close to the thickest allowable specification, causing the windshields of those models having serial numbers in a certain range to experience cracks from impact by road debris at a lower frequency than normal. Thus, the cost of repairs for vehicles in that serial number range would be lower than normal for vehicles of the subject model built in the same model year. The AI Engine 22 disclosed herein may recognize that a particular vehicle matches the pattern of vehicles (e.g., particular model in a certain serial number range) that experience low windshield breakage costs. This recognition may be possible even though the model in general (i.e., over the entire population of serial numbers) does not match the pattern. Thus, the risk estimate 23 generated by the AI Engine 22 of the present disclosure would be more accurate for the particular vehicle, and allow a service contract to be offered to the potential insured 19 for the particular vehicle at a lower cost than would be provided by a typical insurance rating system without causing the insurer to take on more risk.

In some examples of the present disclosure, the receiving of the insurance data 11 into the network computer memory 12 may be via a Point-Of-Sale System 29. The Point-Of-Sale System 29 may be connected to the computer network 20. The Point-Of-Sale System 29 may be any suitable device in communication with the computer network 20 that can communicate with a potential customer or sales representative. For example, the Point-Of-Sale System 29 connected to the computer network 20 may be selected from the group consisting of: a smart phone; a PC; a tablet computer; a computer terminal; a computer workstation; and a notebook computer.

In some examples of the present disclosure, the computer implemented method may include transforming the risk estimate 23 to a premium 30 via the computer network 20. The computer implemented method may include communicating the risk estimate 23 to the Risk Estimating API 25. For example, a Premium Markup API 31 may be connected to the computer network 20 to receive the risk estimate 23 from the Risk Estimating API 25.

The computer implemented method may include communicating, via the Risk Estimating API 25, the risk estimate 23 to the Premium Markup API 31, and determining, via the Premium Markup API 31, the premium 30 based on the risk estimate 23. Thus, the risk estimate 23 may be transformed by a Premium Markup API 31 to the premium 30. For example, the Premium Markup API 31 may add certain costs and or fees to the risk estimate 23 to calculate the premium 30. The costs and fees may include, for example and without limitation: overhead, profit, license fees, commissions, and expenses. In some examples of the present disclosure, the computer implemented method may include communicating the premium 30 via the computer network 20. Communicating the premium 30 via the computer network 20 may include communicating the premium 30 via a Point-Of-Sale System 29. The computer implemented method may include communicating, via the Premium Markup API 31, the premium 30 to a receiver on the computer network 20. For example, the Premium Markup API 31 may transmit the premium 30 to a Rates API 26 connected to the network 20. The Rates API 26 may transmit the premium 30 to a Point-Of-Sale System 29 connected to the network 20.

In examples, the communicating of the premium 30 via the Point-Of-Sale System 29 may be selected from the group consisting of: displaying the premium 30 on a display connected to the Point-Of-Sale System 29; printing the premium 30 on media by a printer connected to the Point-Of-Sale System 29; producing sounds from the Point-Of-Sale System 29 that communicate the premium 30; and saving data on a removable computer memory in communication with the Point-Of-Sale System 29.

In some examples of the present disclosure, the computer implemented method may include training the risk model 24 with training data including related asset characteristics 33 of related assets 32, historical insured characteristics 34 and cost-related data 35. In examples, the cost-related data 35 may be any data related to cost of insuring the related data. The cost-related data 35 may be selected from the group consisting of: a cost of maintaining, repairing or replacing a component of the related assets; a quantity of a component that is associated with the related asset; and a service interval between service events. An example of how a quantity of components may be cost-related data is: it could cost less to replace 4 spark plugs in a 4 cylinder gasoline engine compared to 8 spark plugs in an 8 cylinder gasoline engine. An example of how a service interval may be cost-related data is: a battery that lasts 5 years compared to 3 years may affect the cost of battery replacement if battery replacement is covered in the contract. Here, the service interval is a time interval. Brake pads that last 30,000 miles compared to brake pads that last 75,000 miles may affect the cost of brake pad replacement if brake pad replacement is covered in the contract. Here, the service interval is a mileage interval. If the service interval is a mileage interval, the expected miles driven during the contract period may also be cost-related data.

In some examples, the related asset characteristics 33 may include related features encoded into related Vehicle Identification Numbers and the particular asset characteristics 21 may include particular features encoded into a particular Vehicle Identification Number.

In some examples of the present disclosure, the computer implemented method may include receiving, via a Training System 40 connected to the computer network 20, the historical insured characteristics 34, related asset identifying information 38 regarding the related assets 32, related contract terms 39 and the cost-related data 35. The method may include communicating, from the Training System 40, the historical insured characteristics 34, the related contract terms 39 and the cost-related data 35 to the AI Engine 22. The method may include communicating, from the Training System 40, the related asset identifying information 38 to an Asset Characteristics Query API 27 connected to the computer network 20. The method may include communicating, from the Asset Characteristics Query API 27, the related asset identifying information 38 to an Asset Data Service 28 connected to the computer network 20. The method may include communicating, from the Asset Data Service 28, the related asset characteristics 33 to the Asset Characteristics Query API 27; and communicating, from the Asset Characteristics Query API 27, the related asset characteristics 33 to the AI Engine 22.

In some examples of the present disclosure, an AI System 10 includes the previously mentioned AI Engine 22. The AI Engine 22 may be to determine a risk model 24 for a domain of insurable risks. As depicted in FIG. 1, the insurable risks that define the domain of insurable risks may be historical insurable risks 36. The AI Engine 22 may be to determine a risk estimate 23 for a particular insurable risk 17 by applying the particular insurable risk 17 to the risk model 24. The particular insurable risk 17 may include particular contract terms 15. The particular contract terms 15 may include insurance coverage for the particular insurable risk 17. In some examples, the risk model 24 is to be trained based on a cost of covering related contract terms 39 for related assets 32 having relationships to the particular insurable risk 17 and for historical insureds 37 having relationships to the particular insurable risk 17. The relationships of the related assets 32 to the particular insurable risk 17 are to be determined by the AI Engine 22. For example, the AI Engine 22 may determine how similar the related assets 32 are to the particular insurable risk 17. For example, the AI Engine 22 may determine what weight would be given to various characteristics of the related assets 32 in the risk model 24. As used in the previous sentence, “weight” means a calculable relationship, or transfer function to be applied to a characteristic of a related asset in the risk model 24. An example of a calculable relationship may include a coefficient by which a variable representing the characteristic of the related asset is multiplied. The relationships of the historical insureds 37 to the particular insurable risk 17 are to be determined by the AI Engine 22.

In some examples, the related assets 32 include vehicles and components of the vehicles. The particular contract terms 15 may include terms of a particular vehicle service contract. The related contract terms 39 may include terms for a related vehicle service contract.

In some examples, the risk model 24 is a continuous function of risk factors, and the risk factors may be determined by the AI Engine 22.

In some examples, the AI System 10 may include a Risk Estimating API 25 connected to a computer network 20 to receive particular asset identifying information 14 regarding a particular asset 18 associated with the particular insurable risk 17, potential insured characteristics 13 regarding a potential insured 19 associated with the particular insurable risk 17, and the particular contract terms 15 of a particular asset-related contract associated with the particular insurable risk 17. The Risk Estimating API 25 may be to communicate the potential insured characteristics 13 and the particular contract terms 15 to the AI Engine 22. The Risk Estimating API 25 may be to communicate the particular asset identifying information 14 to an Asset Characteristics Query API 27, and the Risk Estimating API 25 may be to receive the risk estimate 23 from the AI Engine 22. The Asset Characteristics Query API 27 may be to receive the particular asset identifying information 14 from the Risk Estimating API 25. The Asset Characteristics Query API 27 may be to communicate the particular asset identifying information 14 to an Asset Data Service 28 connected to the computer network 20. The Asset Characteristics Query API 27 may be to receive particular asset characteristics 21 from the Asset Data Service 28. The Asset Characteristics Query API 27 may be to communicate the particular asset characteristics 21 to the AI Engine 22.

The AI System 10 disclosed herein may be structured so that the particular insurable risk 17 data is provided to the trained model to get the risk estimate 23. The AI System 10 may include a Point-Of-Sale System 29 connected to a computer network 20. The AI Engine 22 may be connected to the computer network 20. The Point-Of-Sale System 29 may be to receive potential insured characteristics 13 regarding a potential insured 19 associated with the particular insurable risk 17, particular asset identifying information 14 regarding a particular asset 18 associated with the particular insurable risk 17, and the particular contract terms 15 of a particular asset-related contract associated with the particular insurable risk 17.

A Rates API 26 may be connected to the computer network 20 to receive the particular asset identifying information 14, the potential insured characteristics 13, and the particular contract terms 15 from the Point-Of-Sale System 29. A Risk Estimating API 25 may be connected to the computer network 20 to receive the particular asset identifying information 14, the potential insured characteristics 13, and the particular contract terms 15 from the Rates API 26. The Risk Estimating API 25 may be to communicate the potential insured characteristics 13 and the particular contract terms 15 to the AI Engine 22. The Risk Estimating API 25 may be to communicate the particular asset identifying information 14 to an Asset Characteristics Query API 27, and the Risk Estimating API 25 may be to receive the risk estimate 23 from the AI Engine 22.

The Asset Characteristics Query API 27 may be connected to the computer network 20 to receive the particular asset identifying information 14 from the Risk Estimating API 25. The Asset Characteristics Query API 27 may be to communicate the particular asset identifying information 14 to an Asset Data Service 28 connected to the computer network 20. The Asset Characteristics Query API 27 may be to receive particular asset characteristics 21 from the Asset Data Service 28. The Asset Characteristics Query API 27 may be to communicate the particular asset characteristics 21 to the AI Engine 22.

In examples, the particular asset characteristics 21 may include particular features encoded into a particular Vehicle Identification Number.

Post Processing Aspects of the AI System

The AI System 10 may include a Premium Markup API 31 connected to a computer network 20 to receive the risk estimate 23 from the AI Engine 22. The Premium Markup API 31 may be to determine a premium 30 based on the risk estimate 23. The Premium Markup API 31 may be to communicate the premium 30 to a Rates API 26 connected to the computer network 20. The Rates API 26 may be to communicate the premium 30 to a Point-Of-Sale System 29. The Point-Of-Sale System 29 may be to communicate the premium 30, for example, to a potential customer or sales representative.

The Point-Of-Sale System 29 may be to communicate the premium 30 by performing an action selected from the group consisting of: displaying the premium 30 on a display connected to the Point-Of-Sale System 29; printing the premium 30 on media by a printer connected to the Point-Of-Sale System 29; producing sounds from the Point-Of-Sale System 29 that communicate the premium 30; and saving data on a removable computer memory in communication with the Point-Of-Sale System 29.

Training the AI Engine

In examples of the present disclosure, the AI System 10 may include a Training System 40 connected to a computer network 20. The AI Engine 22 may be connected to the computer network 20. The Training System 40 may be to communicate historical insured characteristics 34 regarding the historical insureds 37 associated with the related assets 32, related asset identifying information 38 regarding the related assets 32, the related contract terms 39 and cost-related data 35 to the AI Engine 22. The computer network 20 may be to connect to an Asset Characteristics Query API 27 to receive the related asset identifying information 38 from the Training System 40. The Asset Characteristics Query API 27 may be to communicate the related asset identifying information 38 to an Asset Data Service 28 connected to the computer network 20. The Asset Characteristics Query API 27 may be to receive related asset characteristics 33 from the Asset Data Service 28. The Asset Characteristics Query API 27 may be to communicate the related asset characteristics 33 to the AI Engine 22.

The related asset characteristics 33 may include related features encoded into related Vehicle Identification Numbers.

In examples of the present disclosure, the AI Engine 22 includes an Artificial Neural Network. The Artificial Neural Network may include a Deep Neural Network. The AI Engine 22 may include a Gradient Boosted Regression Tree. The AI Engine 22 may include a Generalized Linear Model. The Generalized Linear Model may be based on a Tweedie distribution.

Examples for Vehicles and Vehicle Service Contracts

In some examples of the present disclosure, a computer implemented method for rating a particular insurable risk 17 includes receiving insurance data 11 into a network computer memory 12 connected to a computer network 20. The insurance data 11 may include potential insured characteristics 13 regarding a potential insured 19 associated with the particular insurable risk 17, a particular Vehicle Identification Number for a particular vehicle associated with the particular insurable risk 17, and particular contract terms 15 of a particular vehicle service contract associated with the particular insurable risk 17. The computer implemented method may include determining particular vehicle characteristics based on the particular Vehicle Identification Number. The computer implemented method may include training, via an AI Engine 22 in the computer network 20, a risk model 24 with training data including related vehicle characteristics of related vehicles, historical insured characteristics 34 and cost-related data 35. In some examples, the cost-related data 35 may be selected from the group consisting of: a cost of maintaining, repairing or replacing a component of the related vehicle; a quantity of a component that is associated with the related vehicle; and a service interval between service events.

The computer implemented method may include determining, via the AI Engine 22, a risk estimate 23 for the particular insurable risk 17 based on the risk model 24. The computer implemented method may include transforming the risk estimate 23 to a premium 30 via the computer network 20, and communicating the premium 30 via the computer network 20.

In examples, the AI Engine 22 may include an Artificial Neural Network. The Artificial Neural Network may include a Deep Neural Network. The AI Engine 22 may include a Gradient Boosted Regression Tree. The AI Engine 22 may include a Generalized Linear Model. The Generalized Linear Model may be based on a Tweedie distribution.

In some examples, the related vehicle characteristics may include related features encoded into related Vehicle Identification Numbers and the particular vehicle characteristics may include particular features encoded into the particular Vehicle Identification Number.

The particular contract terms 15 may include a scope of coverage that includes maintenance, repair or replacement of components that warrant repair or replacement due to causes for which coverage is provided in the particular vehicle service contract.

In some examples of the present disclosure, the risk estimate 23 may be expressed in currency for a time period, and the risk model 24 determined by the AI Engine 22 may be a continuous function.

In some examples of the present disclosure, the computer implemented method may include receiving, via a Training System 40 connected to the computer network 20, the historical insured characteristics 34, related Vehicle Identification Numbers for the related vehicles, related contract terms 39 and the cost-related data 35.

The computer implemented method may include communicating, from the Training System 40, the historical insured characteristics 34, the related contract terms 39 and the cost-related data 35 to the AI Engine 22. The computer implemented method may include communicating, from the Training System 40, the related Vehicle Identification Numbers to an Asset Characteristics Query API 27 connected to the computer network 20.

The computer implemented method may include communicating, from the Asset Characteristics Query API 27, the related Vehicle Identification Numbers to a Vehicle Data Service connected to the computer network 20. The computer implemented method may include communicating, from the Vehicle Data service, the related vehicle characteristics to the Asset Characteristics Query API 27. The computer implemented method may include communicating, from the Asset Characteristics Query API 27, the related vehicle characteristics to the AI Engine 22.

The computer implemented method may include receiving the potential insured characteristics 13, the particular Vehicle Identification Number, and the particular contract terms 15 by a Risk Estimating API 25. The computer implemented method may include communicating, via the Risk Estimating API 25: the particular Vehicle Identification Number to the computer network 20; and the particular contract terms 15 and the potential insured characteristics 13 to the AI Engine 22. The computer implemented method may include receiving, from the computer network 20, the particular vehicle characteristics by the AI Engine 22. The computer implemented method may include communicating, via the Risk Estimating API 25, the potential insured characteristics 13 and the particular contract terms 15 to the AI Engine 22.

The computer implemented method may include: communicating, via a Rates API 26, the potential insured characteristics 13, the particular Vehicle Identification Number, and the particular contract terms 15 to a Risk Estimating API 25; communicating, via the Risk Estimating API 25, the particular Vehicle Identification Number to an Asset Characteristics Query API 27; communicating, via the Asset Characteristics Query API 27, the particular Vehicle Identification Number to a Vehicle Data Service; receiving, by the Asset Characteristics Query API 27, the particular vehicle characteristics from the Vehicle Data Service; and communicating, via the Asset Characteristics Query API 27, the particular vehicle characteristics to the AI Engine 22. In examples, the receiving of the insurance data 11 into the network computer memory 12 may be via a Point-Of-Sale System 29.

The computer implemented method may include: communicating the risk estimate 23 to the Risk Estimating API 25; communicating, via the Risk Estimating API 25, the risk estimate 23 to a Premium Markup API 31; determining, via the Premium Markup API 31, the premium 30 based on the risk estimate 23; communicating, via the Premium Markup API 31, the premium 30 to a Rates API 26 connected to the computer network 20; and communicating the premium 30 via the Rates API 26 to a receiver on the computer network 20.

The computer implemented method may include: communicating the risk estimate 23 to the Risk Estimating API 25; communicating, via the Risk Estimating API 25, the risk estimate 23 to a Premium Markup API 31; determining, via the Premium Markup API 31, the premium 30 based on the risk estimate 23; communicating, via the Premium Markup API 31, the premium 30 to the Rates API 26; and communicating the premium 30 via the Rates API 26 to the Point-Of-Sale System 29.

The computer implemented method may include communicating, via the Rates API 26, the premium 30 to a Point-Of-Sale System 29. In examples, the Point-Of-Sale System 29 may be the receiver on the computer network 20.

In examples of the present disclosure, the communicating the premium 30 via the computer network 20 may include communicating the premium 30 via a Point-Of-Sale System 29. The communicating the premium 30 via the Point-Of-Sale System 29 may be selected from the group consisting of: displaying the premium 30 on a display connected to the Point-Of-Sale System 29; printing the premium 30 on media by a printer connected to the Point-Of-Sale System 29; producing sounds from the Point-Of-Sale System 29 that communicate the premium 30; and saving data on a removable computer memory in communication with the Point-Of-Sale System 29.

In examples of the present disclosure, the Point-Of-Sale System 29 is selected from the group consisting of: a smart phone; a PC; a tablet computer; a computer terminal; a computer workstation; and a notebook computer.

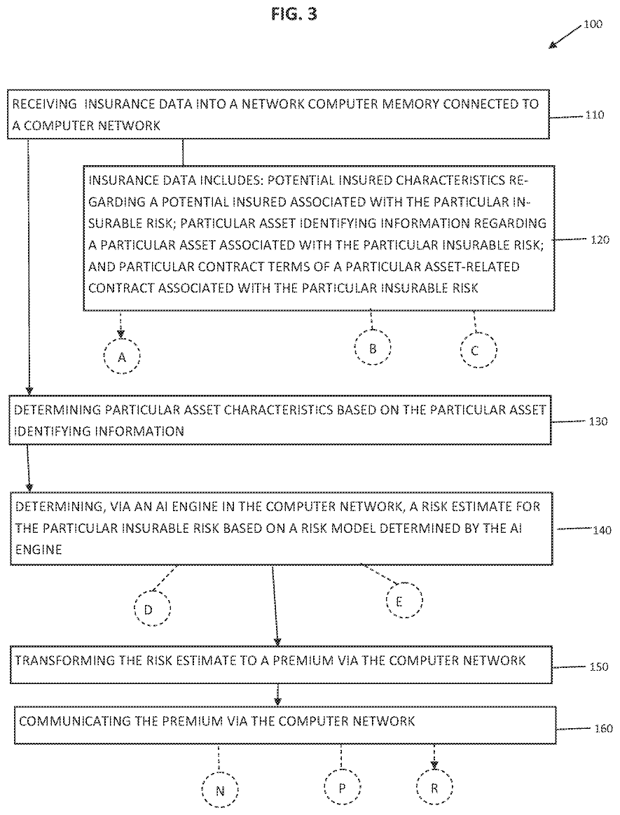

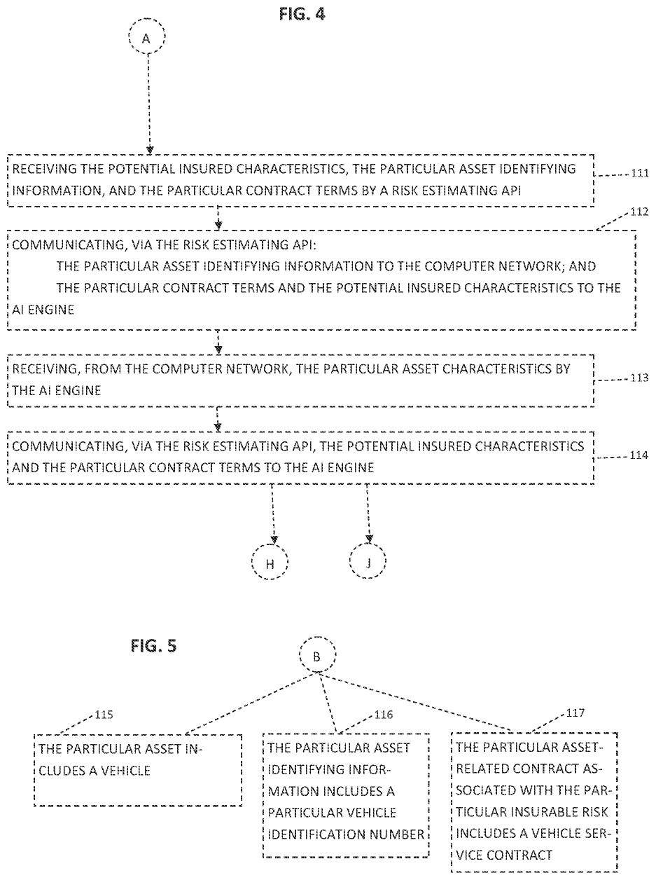

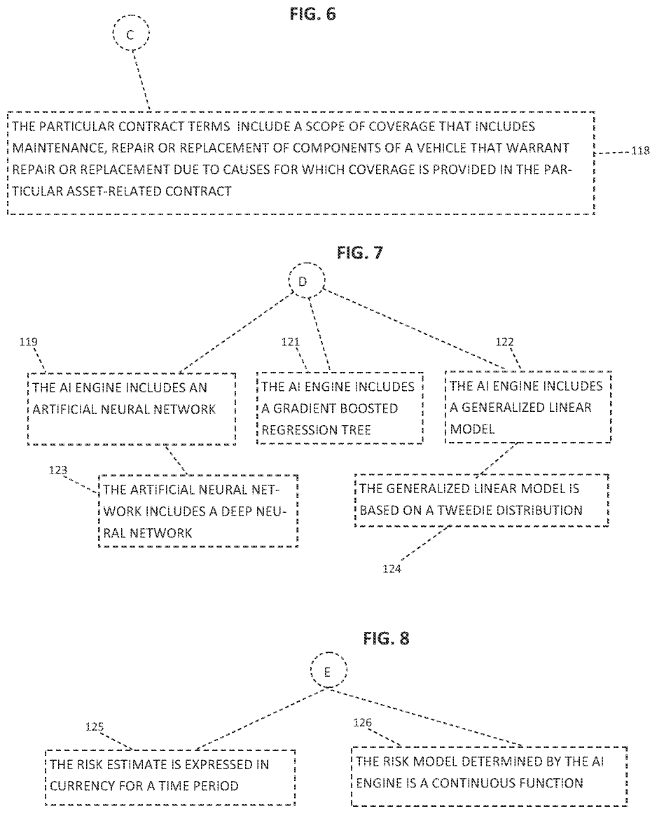

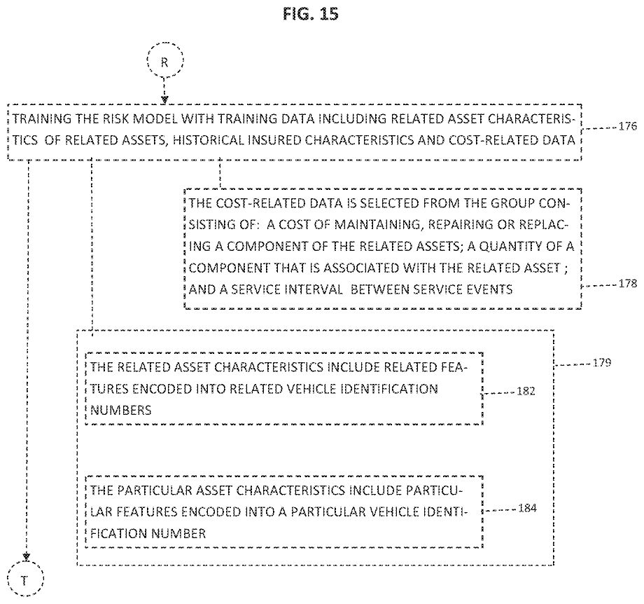

FIG. 3-FIG. 16 together are a flow chart depicting an example of the computer implemented method 100 for rating a particular insurable risk as disclosed herein. FIG. 3 depicts a set of elements shown in boxes included in the method 100. Dashed lines in the flow chart of FIG. 3-FIG. 16 depict elements and steps that may be implemented optionally in the method 100 according to the present disclosure. A flow chart connector A indicates the connection between box 120 (FIG. 3) and box 111 shown in FIG. 4. A flow chart connector B indicates the connection between box 120 (FIG. 3) and boxes 115, 116, and 117 shown in FIG. 5. A flow chart connector C indicates the connection between box 120 (FIG. 3) and box 118 shown in FIG. 6. A flow chart connector D indicates the connection between box 140 (FIG. 3) and boxes 119, 121, and 122 shown in FIG. 7. A flow chart connector E indicates the connection between box 140 (FIG. 3) and boxes 125 and 126 shown in FIG. 8. A flow chart connector N indicates the connection between box 160 (FIG. 3) and boxes 168 and 172 shown in FIG. 13. A flow chart connector P indicates the connection between box 160 (FIG. 3) and box 174 shown in FIG. 14. A flow chart connector R indicates the connection between box 160 (FIG. 3) and box 176 shown in FIG. 15.

In FIG. 3, box 110 depicts, “receiving insurance data into a network computer memory connected to a computer network.” At FIG. 3, box 120, is “Insurance Data includes: potential insured characteristics regarding a potential insured associated with the particular insurable risk; particular asset identifying information regarding a particular asset associated with the particular insurable risk; and particular contract terms of a particular asset-related contract associated with the particular insurable risk.” In FIG. 3, at box 130, is “determining particular asset characteristics based on the particular asset identifying information.” At box 140 is “determining, via an AI Engine in the computer network, a risk estimate for the particular insurable risk based on a risk model determined by the AI Engine.” At box 150 is “transforming the risk estimate to a premium via the computer network.” At box 160 is “communicating the premium via the computer network.”

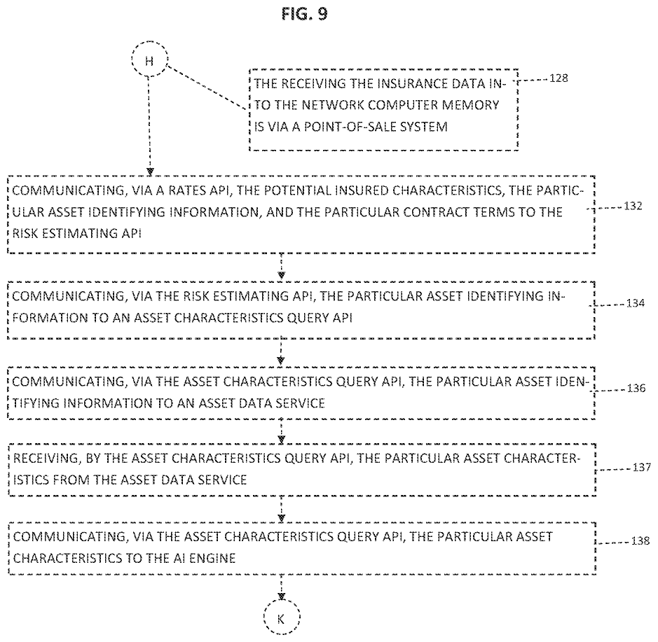

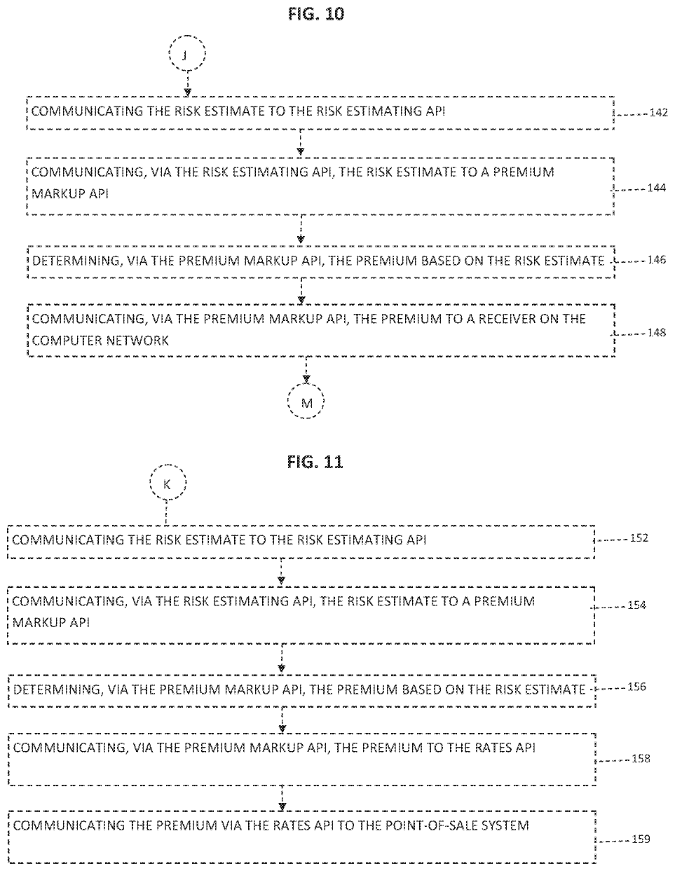

In FIG. 4, the flowchart connector A indicates the connection between box 120 shown in FIG. 3 and box 111. In box 111, FIG. 4 depicts “receiving the potential insured characteristics, the particular asset identifying information, and the particular contract terms by a Risk Estimating API.” At box 112, is “communicating, via the Risk Estimating API: the particular asset identifying information to the computer network; and the particular contract terms and the potential insured characteristics to the AI Engine.” At box 113, is “receiving, from the computer network, the particular asset characteristics by the AI Engine.” At box 114, is “communicating, via the Risk Estimating API, the potential insured characteristics and the particular contract terms to the AI Engine.” A flow chart connector H indicates the connection between box 114 (FIG. 4) and boxes 128 and 132 shown in FIG. 9. A flow chart connector J indicates the connection between box 114 (FIG. 4) and box 142 shown in FIG. 10.

In FIG. 5, the flowchart connector B indicates the connection between box 120 shown in FIG. 3 and boxes 115, 116, and 117. In box 115, FIG. 5 depicts “the particular asset includes a vehicle.” At box 116, is “the particular asset identifying information includes a particular Vehicle Identification Number.” At box 117, is “the particular asset-related contract associated with the particular insurable risk includes a vehicle service contract.”

In FIG. 6, the flowchart connector C indicates the connection between box 120 shown in FIG. 3 and box 118. In box 118, FIG. 6 depicts “the particular contract terms include a scope of coverage that includes maintenance, repair or replacement of components of a vehicle that warrant repair or replacement due to causes for which coverage is provided in the particular asset-related contract.”

In FIG. 7, the flowchart connector D indicates the connection between box 140 shown in FIG. 3 and boxes 119, 121 and 122. In box 119, FIG. 7 depicts “the AI Engine includes an Artificial Neural Network.” At box 121, is “the AI Engine includes a Gradient Boosted Regression Tree.” At box 122, is “the AI Engine includes a Generalized Linear Model.” At box 123, which depends from box 119 in FIG. 7, is “the Artificial Neural Network includes a Deep Neural Network.” At box 124, which depends from box 122 in FIG. 7, is “the Generalized Linear Model is based on a Tweedie distribution.”

In FIG. 8, the flowchart connector E indicates the connection between box 140 shown in FIG. 3 and boxes 125 and 126. In box 125, FIG. 8 depicts “the risk estimate is expressed in currency for a time period.” At box 126, is “the risk model determined by the AI Engine is a continuous function.”

In FIG. 9, the flowchart connector H indicates the connection between box 114 shown in FIG. 4 and boxes 128 and 132. In box 128, FIG. 9 depicts “the receiving the insurance data into the network computer memory is via a point-of-sale system.” At box 132, is “communicating, via a Rates API, the potential insured characteristics, the particular asset identifying information, and the particular contract terms to the Risk Estimating API.” At box 134, is “communicating, via the Risk Estimating API, the particular asset identifying Information to an Asset Characteristics Query API.” At box 136, is “communicating, via the Asset Characteristics Query API, the particular asset identifying information to an Asset Data Service.” At box 137, is “receiving, by the Asset Characteristics Query API, the particular asset characteristics from the Asset Data Service.” At box 138, is “communicating, via the Asset Characteristics Query API, the particular asset characteristics to the AI Engine.” A flow chart connector K indicates the connection between box 138 (FIG. 9) and box 152 shown in FIG. 11.

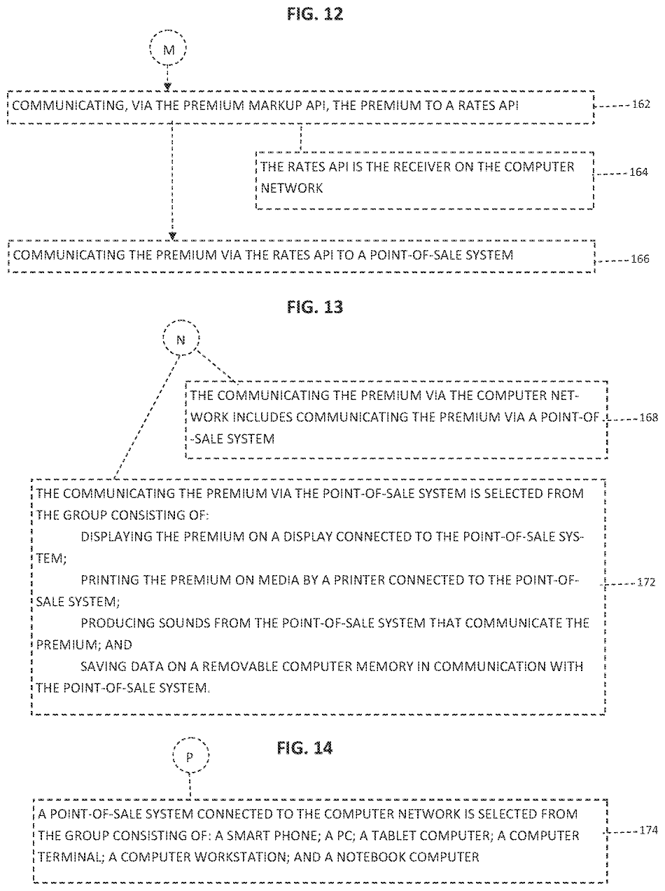

In FIG. 10, the flowchart connector J indicates the connection between box 114 shown in FIG. 4 and box 142. In box 142, FIG. 10 depicts “communicating the risk estimate to the Risk Estimating API.” At box 144, is “communicating, via the Risk Estimating API, the risk estimate to a Premium Markup API.” At box 146, is “determining, via the Premium Markup API, the premium based on the risk estimate.” At box 148, is “communicating, via the Premium Markup API, the premium to a receiver on the computer network.” A flow chart connector M indicates the connection between box 148 (FIG. 10) and box 162 shown in FIG. 12.

In FIG. 11, the flowchart connector K indicates the connection between box 138 shown in FIG. 9 and box 152. In box 152, FIG. 11 depicts “communicating the risk estimate to the Risk Estimating API.” At box 154, is “communicating, via the Risk Estimating API, the risk estimate to a Premium Markup API.” At box 156, is “determining, via the Premium Markup API, the premium based on the risk estimate.” At box 158, is “communicating, via the Premium Markup API, the premium to the Rates API.” At box 159, is “communicating the premium via the Rates API to the point-of-sale system.”

In FIG. 12, the flowchart connector M indicates the connection between box 148 shown in FIG. 10 and box 162. In box 162, FIG. 12 depicts “communicating, via the Premium Markup API, the premium to a Rates API.” At box 164, is “the Rates API is the receiver on the computer network.” At box 166, is “communicating the premium via the Rates API to a point-of-sale system.”

In FIG. 13, the flowchart connector N indicates the connection between box 160 shown in FIG. 3 and boxes 168 and 172. In box 168, FIG. 13 depicts “the communicating the premium via the computer network includes communicating the premium via a point-of-sale system.” At box 172, is “the communicating the premium via the point-of-sale system is selected from the group consisting of: displaying the premium on a display connected to the point-of-sale system; printing the premium on media by a printer connected to the point-of-sale system; Producing sounds from the point-of-sale system that communicate the premium; and saving data on a removable computer memory in communication with the point-of-sale system.”

In FIG. 14, the flowchart connector P indicates the connection between box 160 shown in FIG. 3 and box 174. In box 174, FIG. 13 depicts “a point-of-sale system connected to the computer network is selected from the group consisting of: a smart phone; a PC; a tablet computer; a computer terminal; a computer workstation; and a notebook computer.”

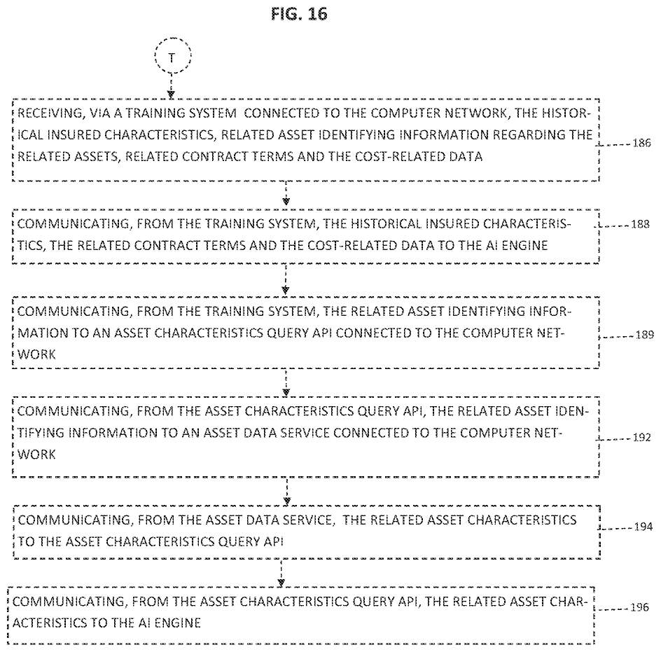

In FIG. 15, the flowchart connector R indicates the connection between box 160 shown in FIG. 3 and box 176. In box 176, FIG. 15 depicts “training the risk model with training data including related asset characteristics of related assets, historical insured characteristics and cost-related data.” At box 178, is “the cost-related data is selected from the group consisting of: a cost of maintaining, repairing or replacing a component of the related assets; a quantity of a component that is associated with the related asset; and a service interval between service events.” In box 179 are two boxes 182 and 184. At box 182, is “the related asset characteristics include related features encoded into related Vehicle Identification Numbers.” At box 184, is “the particular asset characteristics include particular features encoded into a particular Vehicle Identification Number.” A flow chart connector T indicates the connection between box 176 (FIG. 15) and box 186 shown in FIG. 16.

In FIG. 16, the flowchart connector T indicates the connection between box 176 shown in FIG. 15 and box 186. In box 186, FIG. 16 depicts “receiving, via a Training System connected to the computer network, the historical insured characteristics, related asset identifying information regarding the related assets, related contract terms and the cost-related data.” At box 188, is “communicating, from the Training System, the historical insured characteristics, the related contract terms and the cost-related data to the AI Engine.” At box 189, is “communicating, from the Training System, the related asset identifying information to an Characteristics Query API connected to the computer network.” At box 192, is “communicating, from the Asset Characteristics Query API, the related asset identifying information to an Asset Data Service connected to the computer network.” At box 194, is “communicating, from the Asset Data service, the related asset characteristics to the Asset Characteristics Query API.” At box 196, is “communicating, from the Asset Characteristics Query API, the related asset characteristics to the AI Engine.”

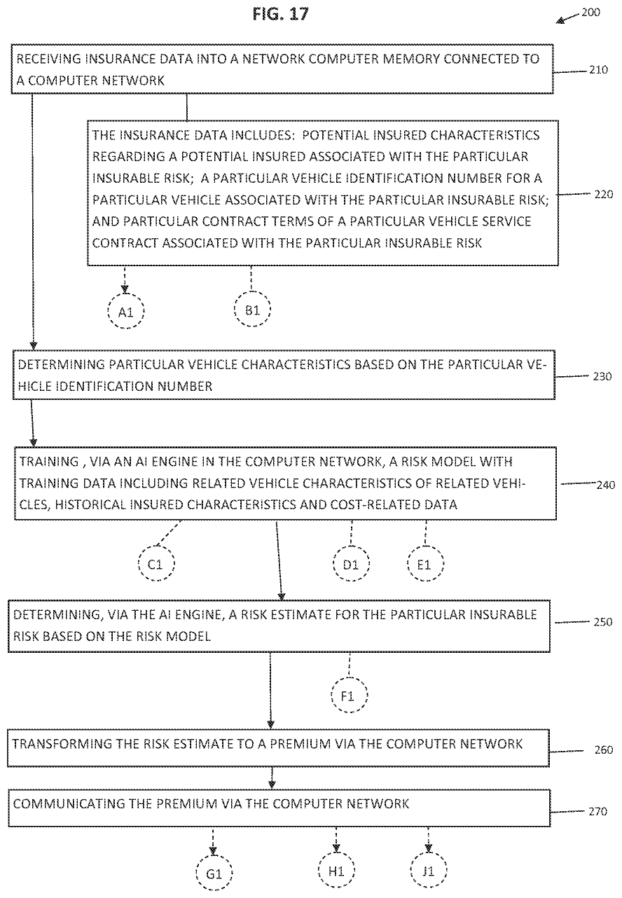

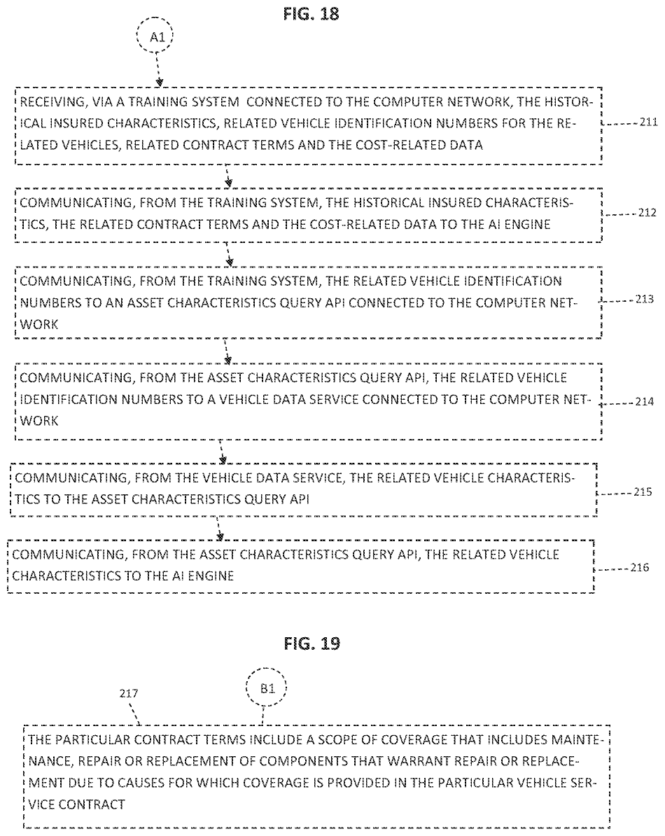

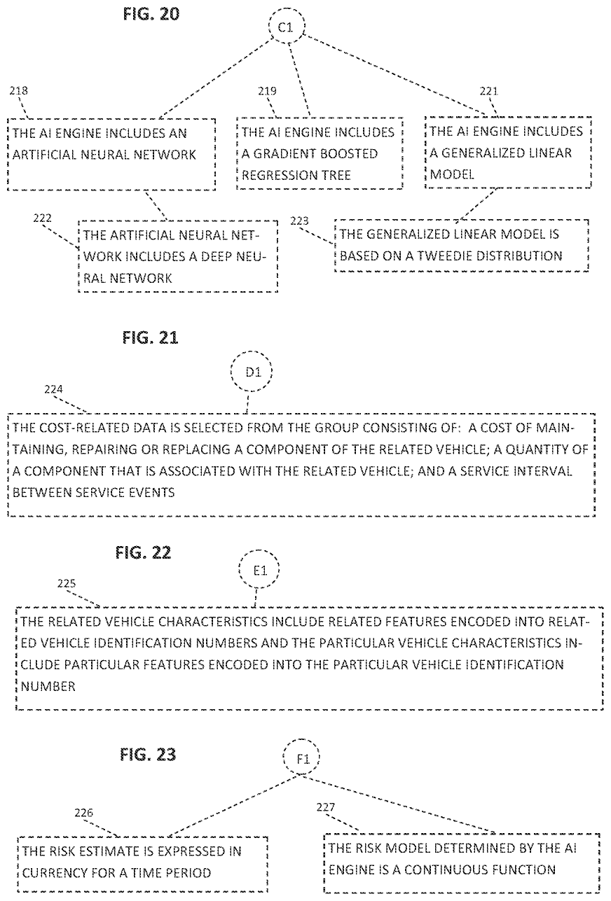

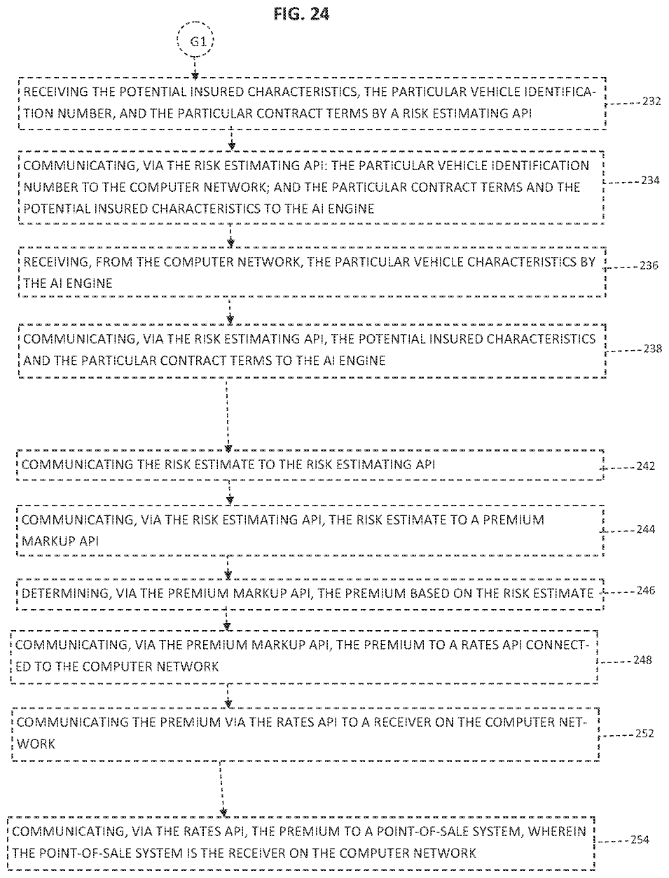

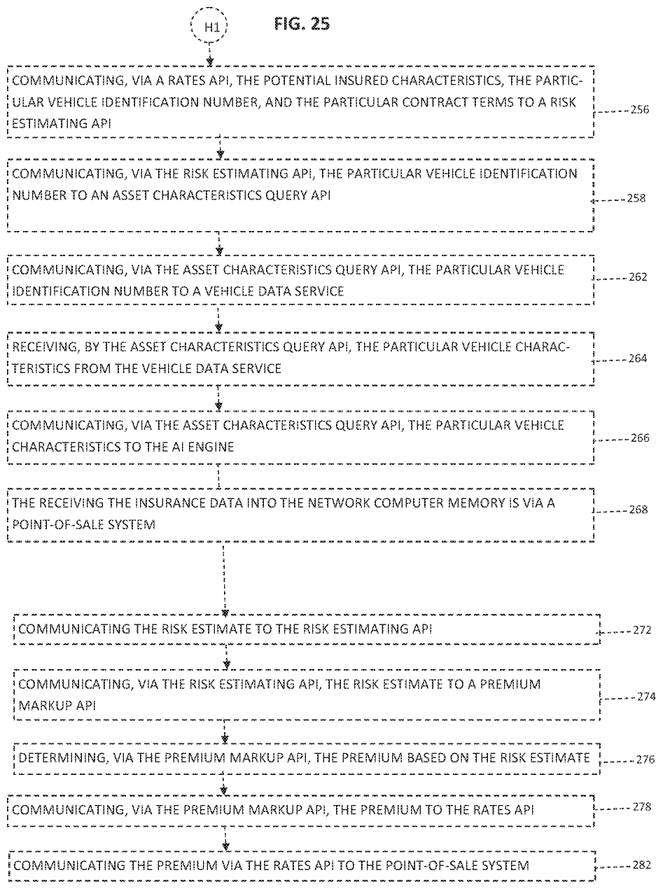

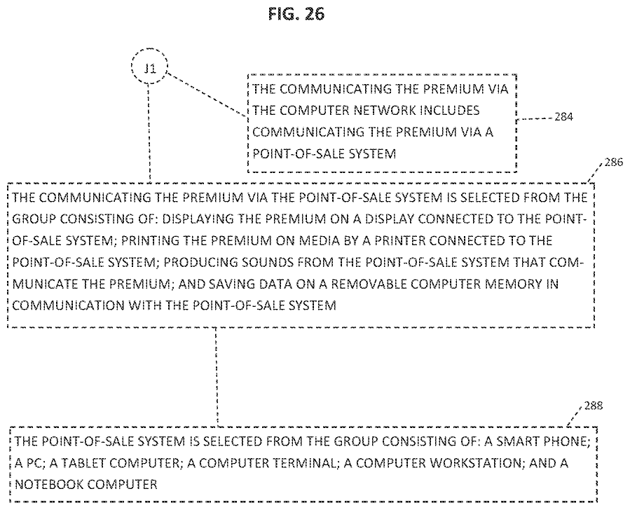

FIG. 17-FIG. 26 together are a flow chart depicting an example of the computer implemented method 200 for rating a particular insurable risk as disclosed herein. FIG. 17 depicts a set of elements shown in boxes included in the method 200. Dashed lines in the flow chart of FIG. 17-FIG. 26 depict elements and steps that may be implemented optionally in the method 200 according to the present disclosure. A flow chart connector AI indicates the connection between box 220 (FIG. 17) and box 211 shown in FIG. 18. A flow chart connector B1 indicates the connection between box 220 (FIG. 17) and box 217 shown in FIG. 19. A flow chart connector Cl indicates the connection between box 240 (FIG. 17) and boxes 218, 219 and 221 shown in FIG. 20. A flow chart connector D1 indicates the connection between box 240 (FIG. 17) and box 224 shown in FIG. 21. A flow chart connector E1 indicates the connection between box 240 (FIG. 17) and box 225 shown in FIG. 22. A flow chart connector F1 indicates the connection between box 250 (FIG. 17) and boxes 226 and 227 shown in FIG. 23. A flow chart connector G1 indicates the connection between box 270 (FIG. 17) and box 232 shown in FIG. 24. A flow chart connector H1 indicates the connection between box 270 (FIG. 17) and box 256 shown in FIG. 25. A flow chart connector J1 indicates the connection between box 270 (FIG. 17) and boxes 284 and 286 shown in FIG. 26.

In FIG. 17, box 210 depicts, “receiving insurance data into a network computer memory connected to a computer network.” At FIG. 17, box 220, is “the insurance data includes: potential insured characteristics regarding a potential insured associated with the particular insurable risk; a particular Vehicle Identification Number for a particular vehicle associated with the particular insurable risk; and particular contract terms of a particular vehicle service contract associated with the particular insurable risk.” In FIG. 17, at box 230, is “determining particular vehicle characteristics based on the particular Vehicle Identification Number.” At box 240 is “training, via an AI Engine in the computer network, a risk model with training data including related vehicle characteristics of related vehicles, historical insured characteristics and cost-related data.” At box 250 is “determining, via the AI Engine, a risk estimate for the particular insurable risk based on the risk model.” At box 260 is “transforming the risk estimate to a premium via the computer network.” At box 270 is “communicating the premium via the computer network.”

In FIG. 18, the flowchart connector AI indicates the connection between box 220 shown in FIG. 17 and box 211. In box 211, FIG. 18 depicts “receiving, via a Training System connected to the computer network, the historical insured characteristics, related Vehicle Identification Numbers for the related vehicles, related contract terms and the cost-related data.” At box 212, is “communicating, from the Training System, the historical insured characteristics, the related contract terms and the cost-related data to the AI Engine.” At box 213, is “communicating, from the Training System, the related Vehicle Identification Numbers to an Asset Characteristics Query API connected to the computer network.” At box 214, is “communicating, from the Asset Characteristics Query API, the related Vehicle Identification Numbers to a Vehicle Data Service connected to the computer network.” At box 215, is “communicating, from the Vehicle Data service, the related vehicle characteristics to the Asset Characteristics Query API.” At box 216, is “communicating, from the Asset Characteristics Query API, the related vehicle characteristics to the AI Engine.”

In FIG. 19, the flowchart connector B1 indicates the connection between box 220 shown in FIG. 17 and box 217. In box 217, FIG. 19 depicts “the particular contract terms include a scope of coverage that includes maintenance, repair or replacement of components that warrant repair or replacement due to causes for which coverage is provided in the particular vehicle service contract.”

In FIG. 20, the flowchart connector Cl indicates the connection between box 240 shown in FIG. 17 and boxes 218, 219 and 221. In box 218, FIG. 20 depicts “the AI Engine includes an Artificial Neural Network.” At box 219, is “the AI Engine includes a Gradient Boosted Regression Tree.” At box 221, is “the AI Engine includes a Generalized Linear Model.” At box 222, which depends from box 218 in FIG. 20, is “the Artificial Neural Network includes a Deep Neural Network.” At box 223, which depends from box 221 in FIG. 20, is “the Generalized Linear Model is based on a Tweedie distribution.”

In FIG. 21, the flowchart connector D1 indicates the connection between box 240 shown in FIG. 17 and box 224. In box 224, FIG. 21 depicts “the cost-related data is selected from the group consisting of: a cost of maintaining, repairing or replacing a component of the related vehicle; a quantity of a component that is associated with the related vehicle; and a service interval between service events.”

In FIG. 22, the flowchart connector E1 indicates the connection between box 240 shown in FIG. 17 and box 225. In box 225, FIG. 22 depicts “the related vehicle characteristics include related features encoded into related Vehicle Identification Numbers and the particular vehicle characteristics include particular features encoded into the particular Vehicle Identification Number.”

In FIG. 23, the flowchart connector F1 indicates the connection between box 250 shown in FIG. 17 and boxes 226 and 227. In box 226, FIG. 23 depicts “the risk estimate is expressed in currency for a time period.” At box 227, is “the risk model determined by the AI Engine is a continuous function.”

In FIG. 24, the flowchart connector G1 indicates the connection between box 270 shown in FIG. 17 and box 232. In box 232, FIG. 24 depicts “receiving the potential insured characteristics, the particular Vehicle Identification Number, and the particular contract terms by a Risk Estimating API.” At box 234, is “communicating, via the Risk Estimating API: the particular Vehicle Identification Number to the computer network; and the particular contract terms and the potential insured characteristics to the AI Engine.” At box 236, is “receiving, from the computer network, the particular vehicle characteristics by the AI Engine.” At box 238, is “communicating, via the Risk Estimating API, the potential insured characteristics and the particular contract terms to the AI Engine.” At box 242, is “communicating the risk estimate to the Risk Estimating API.” At box 244, is “communicating, via the Risk Estimating API, the risk estimate to a Premium Markup API.” At box 246, is “determining, via the Premium Markup API, the premium based on the risk estimate.” At box 248, is “communicating, via the Premium Markup API, the premium to a Rates API connected to the computer network.” At box 252, is “communicating the premium via the Rates API to a receiver on the computer network.” At box 254, is “communicating, via the Rates API, the premium to a point-of-sale system, wherein the point-of-sale system is the receiver on the computer network.”

In FIG. 25, the flowchart connector H1 indicates the connection between box 270 shown in FIG. 17 and box 256. In box 256, FIG. 25 depicts “communicating, via a Rates API, the potential insured characteristics, the particular Vehicle Identification Number, and the particular contract terms to a Risk Estimating API.” At box 258, is “communicating, via the Risk Estimating API, the particular Vehicle Identification Number to an Asset Characteristics Query API.” At box 262, is “communicating, via the Asset Characteristics Query API, the particular Vehicle Identification Number to a Vehicle Data Service.” At box 264, is “receiving, by the Asset Characteristics Query API, the particular vehicle characteristics from the Vehicle Data Service.” At box 266, is “communicating, via the Asset Characteristics Query API, the particular vehicle characteristics to the AI Engine.” At box 268, is “the receiving the insurance data into the network computer memory is via a point-of-sale system.” At box 272, is “communicating the risk estimate to the Risk Estimating API.” At box 274, is “communicating, via the Risk Estimating API, the risk estimate to a Premium Markup API.” At box 276, is “determining, via the Premium Markup API, the premium based on the risk estimate.” At box 278, is “communicating, via the Premium Markup API, the premium to the Rates API.” At box 282, is “communicating the premium via the Rates API to the point-of-sale system.”

In FIG. 26, the flowchart connector J1 indicates the connection between box 270 shown in FIG. 17 and boxes 284 and 286. In box 284, FIG. 26 depicts “the communicating the premium via the computer network includes communicating the premium via a point-of-sale system.” At box 286, is “the communicating the premium via the point-of-sale system is selected from the group consisting of: displaying the premium on a display connected to the point-of-sale system; printing the premium on media by a printer connected to the point-of-sale system; producing sounds from the point-of-sale system that communicate the premium; and saving data on a removable computer memory in communication with the point-of-sale system.” At box 288, is “the point-of-sale system is selected from the group consisting of: a smart phone; a PC; a tablet computer; a computer terminal; a computer workstation; and a notebook computer.”

The methods and systems described above may be realized in hardware, software or any combination of hardware and software suitable for a particular application. The processes may be realized in one or more microprocessors, microcontrollers or other programmable devices, along with computer memory. In some examples, the portions of the method may be executed by an application specific integrated circuit (ASIC), a programmable gate array, programmable array logic, or any other device that may be configured to process electronic signals. In some examples, the processes may be realized as a computer executable code capable of being executed on a machine-readable medium. In some examples, the machine-readable medium may be a non-transitory computer-readable medium. Some examples include a non-transitory computer-readable medium to store instructions that when executed by a processor, perform operations including one or more of the system or computer implemented method elements disclosed herein.

In examples, the processor may comprise any suitable processor. In some examples the processor may comprise a neural processing chip, or a graphics processor. Processors may be connected in a fabric implementation of a large scale neural network to execute massively parallel computing for high-speed neural network execution.

### ADDITIONAL NOTES

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range, as if such values or sub-ranges were explicitly recited. For example, a range of about 40,000 miles to about 100,000 miles, should be interpreted to include not only the explicitly recited limits of about 40,000 miles to about 100,000 miles, but also to include individual values, such as about 42,000 miles, about 75,000 miles, etc., and sub-ranges, such as from about 42,500 miles to about 82,500 miles, from about 50,000 miles to about 95,000 miles, etc. Furthermore, when “about” and/or “substantially” are/is utilized to describe a value, they are meant to encompass minor variations (up to +/−10%) from the stated value.

While several examples have been described in detail, it is to be understood that the disclosed examples may be modified. Therefore, the foregoing description is to be considered non-limiting.

What is claimed is:

1. A computer implemented method for rating a particular insurable risk, comprising:
receiving insurance data into a network computer memory connected to a computer network, wherein the insurance data includes:
potential insured characteristics regarding a potential insured associated with the particular insurable risk;
particular asset identifying information regarding a particular asset associated with the particular insurable risk; and
particular contract terms of a particular asset-related contract associated with the particular insurable risk;
determining particular asset characteristics based on the particular asset identifying information;
determining, via an AI Engine in the computer network, a risk estimate for the particular insurable risk based on a risk model determined by the AI Engine;
transforming the risk estimate to a premium via the computer network; and
communicating the premium via the computer network.

2. The method as defined in claim 1 wherein the AI Engine includes an Artificial Neural Network.

3. The method as defined in claim 2 wherein the Artificial Neural Network includes a Deep Neural Network.

4. The method as defined in claim 1 wherein the AI Engine includes a Gradient Boosted Regression Tree.

5. The method as defined in claim 1 wherein the AI Engine includes a Generalized Linear Model.

6. The method as defined in claim 5 wherein the Generalized Linear Model is based on a Tweedie distribution.

7. The method as defined in claim 1 wherein:
the particular asset includes a vehicle;
the particular asset identifying information includes a particular Vehicle Identification Number; and
the particular asset-related contract associated with the particular insurable risk includes a vehicle service contract.

8. The method as defined in claim 1 wherein the particular contract terms include a scope of coverage that includes maintenance, repair or replacement of components of a vehicle that warrant repair or replacement due to causes for which coverage is provided in the particular asset-related contract.

9. The method as defined in claim 1 wherein the risk estimate is expressed in currency for a time period, and wherein the risk model determined by the AI Engine is a continuous function.

10. The method as defined in claim 1, further comprising:
receiving the potential insured characteristics, the particular asset identifying information, and the particular contract terms by a Risk Estimating API;
communicating, via the Risk Estimating API:
the particular asset identifying information to the computer network; and
the particular contract terms and the potential insured characteristics to the AI Engine;
receiving, from the computer network, the particular asset characteristics by the AI Engine; and
communicating, via the Risk Estimating API, the potential insured characteristics and the particular contract terms to the AI Engine.

11. The method as defined in claim 10, further comprising:
communicating, via a Rates API, the potential insured characteristics, the particular asset identifying information, and the particular contract terms to the Risk Estimating API;
communicating, via the Risk Estimating API, the particular asset identifying information to an Asset Characteristics Query API;
communicating, via the Asset Characteristics Query API, the particular asset identifying information to an Asset Data Service;
receiving, by the Asset Characteristics Query API, the particular asset characteristics from the Asset Data Service; and
communicating, via the Asset Characteristics Query API, the particular asset characteristics to the AI Engine,
wherein the receiving the insurance data into the network computer memory is via a point-of-sale system.

12. The method as defined in claim 10, further comprising:
communicating the risk estimate to the Risk Estimating API;
communicating, via the Risk Estimating API, the risk estimate to a Premium Markup API;
determining, via the Premium Markup API, the premium based on the risk estimate;
communicating, via the Premium Markup API, the premium to a receiver on the computer network.

13. The method as defined in claim 11, further comprising:
communicating the risk estimate to the Risk Estimating API;
communicating, via the Risk Estimating API, the risk estimate to a Premium Markup API;
determining, via the Premium Markup API, the premium based on the risk estimate;
communicating, via the Premium Markup API, the premium to the Rates API; and
communicating the premium via the Rates API to the point-of-sale system.

14. The method as defined in claim 12, further comprising:
communicating, via the Premium Markup API, the premium to a Rates API, wherein the Rates API is the receiver on the computer network; and
communicating the premium via the Rates API to a point-of-sale system.

15. The method as defined in claim 1 wherein the communicating the premium via the computer network includes communicating the premium via a point-of-sale system, and wherein the communicating the premium via the point-of-sale system is selected from the group consisting of:
displaying the premium on a display connected to the point-of-sale system;
printing the premium on media by a printer connected to the point-of-sale system;
producing sounds from the point-of-sale system that communicate the premium; and
saving data on a removable computer memory in communication with the point-of-sale system.

16. The method as defined in claim 1 wherein a point-of-sale system connected to the computer network is selected from the group consisting of: a smart phone; a PC; a tablet computer; a computer terminal; a computer workstation; and a notebook computer.

17. The method as defined in claim 1, further comprising training the risk model with training data including related asset characteristics of related assets, historical insured characteristics and cost-related data.

18. The method as defined in claim 17 wherein the cost-related data is selected from the group consisting of: a cost of maintaining, repairing or replacing a component of the related assets; a quantity of a component that is associated with the related asset; and a service interval between service events.

19. The method as defined in claim 17 wherein the related asset characteristics include related features encoded into related Vehicle Identification Numbers and wherein the particular asset characteristics include particular features encoded into a particular Vehicle Identification Number.

20. The method as defined in claim 17, further comprising:
receiving, via a Training System connected to the computer network, the historical insured characteristics, related asset identifying information regarding the related assets, related contract terms and the cost-related data;
communicating, from the Training System, the historical insured characteristics, the related contract terms and the cost-related data to the AI Engine;
communicating, from the Training System, the related asset identifying information to an Asset Characteristics Query API connected to the computer network;
communicating, from the Asset Characteristics Query API, the related asset identifying information to an Asset Data Service connected to the computer network;
communicating, from the Asset Data service, the related asset characteristics to the Asset Characteristics Query API; and
communicating, from the Asset Characteristics Query API, the related asset characteristics to the AI Engine.
